(19) United States
(12) Patent Application Publication
(10) Pub. No.: US 2008/0209265 A1
(43) Pub. Date: Aug. 28, 2008

(54) Information-Processing Method and Apparatus

(75) Inventor: Ryuji Fuchikami, Kasuya-Gun (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 10/564,287

(22) PCT Filed: Jan. 11, 2005
(86) PCT No.: PCT/JP2005/000451

§ 371 Date: Apr. 18, 2008

(30) Foreign Application Priority Data
Jan. 15, 2004 (JP) 2004-008327

(51) Int. Cl. G06F 11/07

(52) U.S. Cl. 714/8; 714/E11.021

(57) ABSTRACT

At a stage of compiling of a source code, range information of a variable that a pointer points and information for a failure recovering are installed into the pointer variable. Since failure recovering information can also be acquired when an illegal pointer access is detected based on range information, a recovering processing suitable for data that has caused the failure is performed according to the failure recovering information. By relating the range information and the failure recovering information with the data address, a data type of a memory area at the failure location can be specified using the failure recovering information (UPPER, LOWER, and FIXED).

### TECHNICAL FIELD

The present invention relates to an information-processing method and apparatus that strengthens a failure-recovering function, and related art thereto.

### BACKGROUND ART

In recent years, the opportunity to develop a program for a built-in device using C language is increasing, and the scale of such a program tends to be increasing remarkably. Therefore, it is difficult to develop, for a short period of time, a program in which a bug does not exist at all and a possibility of causing damage is increasing because a bug is often recognized to exist in an operation phase.

A security hole bug due to a buffer overrun is mentioned as one of such bugs, which are frequently recognized to exist in an operation phase.

An attacker may make illegal data read into an automatic variable area allocated in a stack area at the time of program execution, and may cause a system down and a system crack.

Hereafter, a buffer overrun attack is explained using FIG. 22. In a source code shown in FIG. 22 (a), a function “read_int” calls a function “read_str” internally.

The function “read_str” analyzes externally received data and returns a character string to an array “buf”.

The function “read_int” calls a function “atoi”, converts the acquired character string into a numeric value, and makes the numeric value after conversion as a return value.

More specifically, the function “read_int” receives a character string within the array “buf” that is allocated on the stack as shown in FIG. 22 (b), and an ANSI standard function “atoi” converts the character string within the array “buf” into a numeric value. The numeric value is stored in a register for a return parameter, and concise processing at high speed is executed by referring the address of the call source that exists on the stack.

Here, a character string, which is greater than 32 bytes, shall not be returned as specification of the function “read_str”.

However, it is supposed that the logic inside the function “read_str” is complicated and a bug is latent, where the arbitrary data exceeding 32 bytes is returned to the array “buf” of the function “read_int”, when a specific data is sent.

In such a case, an attacker may create and send data, whose address of an attack code is returned to the stack of the function “read_int”, as shown in FIG. 22 (c).

In the case, the address of the attack code is overwritten on the stack after the function “read_int” calls the function “read_str”.

After the function “atoi” converts a dummy section into a numeric value, the function “read_int” returns to the attack code instead of a calling function.

After such situation occurs, the attacker can execute an arbitrary code by the attack code. Even if the arbitrary code can not be executed, the program runs out of control when the return address becomes illegal. Therefore, a system down may be induced with a high possibility.

At present, attack targets are mainly a server and a personal computer, which are connected to the network, and problems such as a system cracking, virus infection, and setting-up of illegal steps to DoS (denial of service attack) have frequently occurred.

It is expected that built-in devices connected to the network (for example, a cellular phone, and home appliances compatible with the network) keep increasing in number near future.

The built-in devices more likely use C language for hardware control and a high-speed process. It is difficult to modify a program at a time of failure when C language is used.

Since many modules with the same software is often used in order to connect with the network, when a security hole is once revealed in the software, an attacker can easily induce worldwide network failure with a method such as spreading a self-reproduction program, which repeats a legal request to a route DNS server.

There is a possibility of illegal attack against social systems, such as lifelines (for example, water, gas, and electricity), medical care and military affairs, which use the network secondarily.

For example, when a mail function and a Web browser function are installed in a cellular phone and a TV operable to connect with the Internet, a received packet is usually processed by a plurality of protocol stack modules. Then the received packet is processed by an application, and is displayed after the processing by a plurality of display control software for display. Thus, data analyzing processing is performed many times. If there is one imperfect processing to abnormal data, it can become a security hole.

Differing from normal data, abnormal data may have unlimited number of pattern combinations, and in addition, behavior of the network may differ due to timing and traffic confusion, perfect verification is extremely difficult.

When a developed program scale furthermore increases, it is necessary to consider a case of an artificial bug imposed by a programmer with malice who participates in the development and creates a security hole intentionally.

As a matter of fact, there was an instance that a terrorist was in a subcontractor of security-required software development.

In the case, since a security hole can be created by overlooking a check function of buffer overflow and mixing an incorrect check value, it is highly impossible to discover the security hole by extracting with a review or verification. Even when the security hole is discovered, it is difficult to judge whether it has been created intentionally or not.

Therefore, it is necessary to comprise a recovering mechanism in a system that is operable when a bug is recognized to exist, without requiring for a programmer to be aware of the bug when a program source code is described.

(The Prior Art 1)

According to a recovering method which is executed on a processor when program failure occurs, the execution flow includes a step that passes a check point periodically and saves the status during the program is normally operating. When the program failure is detected, the execution flow roles the program back to the last check point and restarts the processing after executing recovering processing (see, for example, Japanese translation of PCT international application No. H9-509515).

The error-recovering method described above is also applicable to a program written by C language. If the method is applied in conjunction with an error-detecting method that has more than certain degree of detection accuracy, the method may provide a merit that the processing can be continued without a system down, even when a program bug is recognized to exist in an operation phase.

(The Prior Art 2)

In another method detecting an illegal memory access in C language, a source code is modified such that, when the source code is compiled, a pointer holds range information that indicates accessible range and checks a range-over access by calling a subroutine for every access. In this way, the method can embed an illegal access-detecting mechanism in the existing C language program (see, for example, Japanese patent application Laid-Open No. H7-225703).

(Problem 1)

According to the prior art 1, the execution flow needs to include a step that passes the check point periodically, therefore, it is difficult to adopt the prior art equally, depending on the program structure.

(Problem 2)

According to the structure described in the prior art 1, processing between the last check point and the failure occurrence is executed twice.

If a program only deals with data, the consistency during the recovering processing can be kept to some extent. However, if the program deals with communication control, unacceptable side effect such as sending out the same packet twice or losing a packet while receiving at the time of failure may occur.

### DISCLOSURE OF THE INVENTION

An object of the present invention is to provide an information-processing apparatus that strengthens a failure-recovering function.

A first aspect of the present invention provides an information-processing method, comprising: relating range information and failure-recovering information to an address of a memory; performing ordinary processes while detecting illegal access to the memory; judging upon detection of the illegal access to the memory whether or not failure-recovering is possible based on the range information and the failure-recovering information; and performing failure-recovering processes when the failure-recovering is possible.

The structure of the present invention can specify data type of a memory area of a fault location using the failure recovering information, by relating the range information and the failure recovering information to the address.

A second aspect of the present invention provides an information-processing method as defined in the first aspect, further comprising: performing halt processes when the failure-recovering is not possible.

According to the structure of the present invention, risk such as destruction of data unrelated to the failure and a system down can be avoided.

A third aspect of the present invention provides an information-processing method as defined in the first aspect, wherein the failure-recovering information includes items of a fixed size attribute and a variable size attribute.

According to the structure of the present invention, a variable that should be in a fixed size or a pointer indicating the variable, and a variable that is permitted to change in size or a pointer indicating the variable can be dealt in different modes.

A fourth aspect of the present invention provides an information-processing method as defined in the third aspect, wherein the variable size attribute includes an upper expanding attribute and a lower expanding attribute.

According to the structure of the present invention, a variable that possesses a different allowable direction of size change (a direction in address) or a pointer indicating the variable can be dealt in different modes depending on the direction.

A fifth aspect of the present invention provides an information-processing method as defined in the second aspect, wherein the performing failure-recovering processes includes storing data if the data is storable.

According to the construction of the present invention, the saved data can be used in case when restart of processing is performed or considered to be performed, after the failure is occurred.

A sixth aspect of the present invention provides an information-processing method as defined in the first aspect, wherein the performing failure-recovering processes includes: judging whether an access type is of read access or of write access; and performing failure-recovering whose content is different according to the judging.

According to the structure of the present invention, failure recovering can be performed in different modes based on the access type.

A seventh aspect of the present invention provides an information-processing method as defined in the sixth aspect, wherein failure-recovering without a specific process is performed when the access type is of write access, and failure-recovering after storing a predetermined value into a current address of the memory is performed when the access type is of read access.

According to the structure of the present invention, when the access type is of write access, risky memory access is avoided, and when the access type is of read access, inconvenience such as runaway state on the side of read-out can be avoided.

An eighth aspect of the present invention provides an information-processing method as defined in the fourth aspect, wherein the judging determines that the failure-recovering is not possible when the failure-recovering information indicates an upper expanding attribute and a downward illegal access to the memory is detected.

A ninth aspect of the present invention provides an information-processing method as defined in the fourth aspect, wherein the judging determines that the failure-recovering is not possible when the failure-recovering information indicates a lower expanding attribute and an upward illegal access to the memory is detected.

A tenth aspect of the present invention provides an information-processing method as defined in the fourth aspect, wherein the judging determines that the failure-recovering is not possible when the failure-recovering information indicates a fixed size attribute.

According to these structures of the present invention, when size change is unsuitable, recovering can be canceled to avoid further risk.

An eleventh aspect of the present invention provides an information-processing method as defined in the first aspect, wherein the performing failure-recovering processes includes: allocating some other area of the memory than an area of the memory where the illegal access has occurred; and accessing the other area of the memory allocated by the allocating.

According to the structure of the present invention, risk can be avoided because access is done in another area.

A twelfth aspect of the present invention provides an information-processing method as defined in the first aspect, wherein the failure-recovering information includes an item of a terminator attribute, and wherein, when the terminator attribute indicates that data should have a terminated value at the end, the failure-recovering processes includes adding the terminated value to the end of the data.

According to the structure of the present invention, safety of process that depends on the terminated value can be improved.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a processor and other elements in consideration of the present invention;

FIG. 2 (a) is an illustration of a source code in consideration of the present invention;

FIGS. 2 (b)-2(d) are explanatory figures of pointer access operation in consideration of the present invention;

FIG. 3 (a) and FIG. 3 (b) are illustrations of a source code in consideration of the present invention;

FIG. 3 (c) is an illustration of a failure recovering file in consideration of the present invention;

FIG. 4 (a) is an explanatory figure of a stack memory in consideration of the present invention;

FIG. 4 (b) is an explanatory figure of a pointer in consideration of the present invention;

FIG. 5 (a) is an illustration of a source code in consideration of the present invention;

FIG. 5 (b) is an illustration showing how a pointer and a variable are related to each other in consideration of the present invention;

FIG. 6 is an illustration showing how a pointer and a variable are related to each other in consideration of the present invention;

FIG. 7 is a block diagram illustrating a processor and other elements in a first embodiment of the present invention;

FIG. 8 is a block diagram of a compiler in the first embodiment of the present invention;

FIG. 9 is a functional block diagram of an information-processing apparatus in the first embodiment of the present invention;

FIG. 10 is a flowchart of an information-processing apparatus in the first embodiment of the present invention;

FIG. 11 is a functional block diagram of a compiler in the first embodiment of the present invention;

FIG. 12 is a flowchart of a compiler in the first embodiment of the present invention;

FIG. 13 is a flowchart of a compiler in the first embodiment (modified) of the present invention;

FIG. 14 is a functional block diagram of a compiler in a second embodiment of the present invention;

FIG. 15 is a flowchart of a compiler in the second embodiment of the present invention;

FIG. 16 is a flowchart of an information processing apparatus in a third embodiment of the present invention;

FIG. 17 is a functional block diagram of a compiler in a fourth embodiment of the present invention;

FIG. 18 is a flowchart of a compiler in the fourth embodiment of the present invention;

FIG. 19 (a) is an illustration of a source code in the fourth embodiment of the present invention;

FIG. 19 (b) is an illustration of a source code in the fourth embodiment of the present invention.

FIG. 20 is a block diagram of a failure information-supervising system in a fifth embodiment of the present invention;

FIG. 21 is a block diagram of a failure information-supervising system in a sixth embodiment of the present invention;

FIG. 22 (a) is an illustration showing the prior source code;

FIG. 22 (b) is an explanatory illustration of the prior stack memory; and

FIG. 22 (c) is an illustration showing data for attack.

### BEST MODE FOR CARRYING OUT THE INVENTION

Embodiments of the present invention are now described with reference to the accompanying drawings.

In advance of explanation of the detailed structure, some consideration by the present invention is described first.

In the prior art 1, if it is possible to return directly to the failure occurrence location after the failure-recovering processes without returning to the check point, setting the check point becomes unnecessary, so that the problem 1 is solved, and the same processing is not executed twice so that the problem 2 is also solved.

Accordingly, a system which allows the execution flow to return directly to the failure occurrence location after the failure-recovering processes can be conceived to cope with the failure of the program described by C language in the operation phase.

The following conditions need to be satisfied in the phase of error detection in order to directly return to the failure occurrence location after the failure-recovering processes.

(Condition 1): Failure can be detected before data other than the failure location is destroyed.

(Condition 2): The memory area of the failure location can be specified after the failure detection.

(Conditions 3): The data type in the meaning of C language for the memory area of the failure location can be specified after the failure detection.

(Condition 4): After the failure detection, the processing can be restarted from the location where the failure is detected or from the location right after this.

An error detection method according to the prior art 2 satisfies (Condition 1), (Condition 2), and (Condition 4).

It is presupposed to use an independent compiler in the method. However, a built-in device executes only a program that is written in a ROM before shipping; therefore, the presupposition is different from that for a server and a personal computer, which are assumed to execute general-purpose application software.

In a built-in system, the ROM is never written with a code that is complied by a complier different from the compiler used by a manufacturer.

Therefore, embedding the failure-recovering function in the phase of compiling the completed C language source code before burning the ROM is not a problem at all.

The object of the prior art 2 lies mainly on early discovery of a bug in the verification production process before program operation. It is possible to use the art as it is, but it may cause the following problems.

(Problem a): Since a check process is software execution, processing amount increases remarkably.

(Problem b): Since interruption occurs in the check step and it is hard to keep consistency when the pointer is changed, the check has to be completed while interrupt is disabled. Therefore, maximum interrupt-disabled time increases, and a system breakdown may be caused in the built-in system.

However, (Problem a) and (Problem b) can be solved by the following operation.

In a similar way to the prior art 2, a function is added to a complier and a library, such that the data that a pointer indicates includes not only the address but also information of the assigned memory range.

For simplicity, the pointer type may be extended to a data type that can hold both of the address and the range information.

For this device, the size of the pointer type increases. However, the device can be practiced while satisfying but not violating the specification of C language, since ANSI-C specification does not restrict the data type of the pointer.

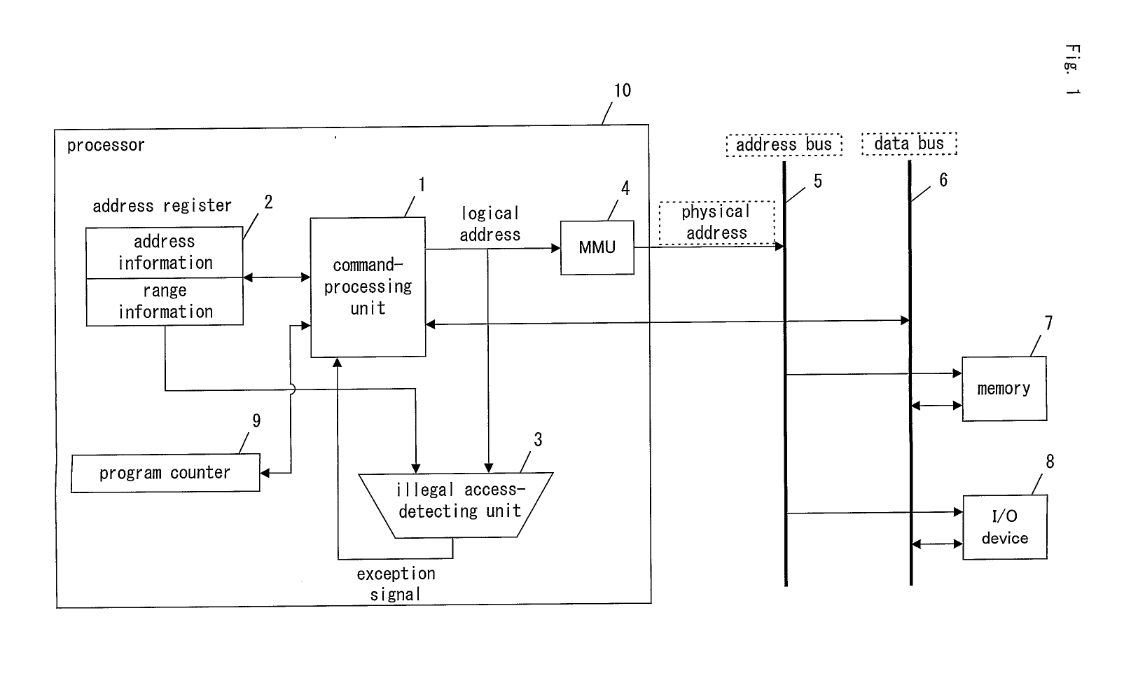

It is preferable to prepare a processor as shown in FIG. 1 in accordance with the structure described above.

FIG. 1 is a block diagram illustrating a processor and other elements in the consideration of the present invention.

As shown in FIG. 1, a processor 10 is connected to a memory 7 and an I/O device 8 etc. via an address bus 5 and a data bus 6. The processor 10 comprises the following components.

A command-processing unit 1 reads in a program on the memory 7, executes the program one after another, and outputs to and inputs from the I/O device 8.

In the present consideration example, it is supposed to set an MMU (Memory Management Unit) 4 between the command-processing unit 1 and the address bus 5. It is also assumed that the command-processing unit 1 and the MMU 4 input and output using a logical address, and the MMU 4 performs conversion between the logical address and a physical address. However, the MMU 4 may be omitted, and the command-processing unit 1 may input and output the physical address.

In addition to the elements included in the regular processor, the following register (preferably comprised with a general-purpose register) is provided in the processor 10 of the present consideration example.

In the processor shown in FIG. 1, an address register 2 is extended from a regular address register, and comprises an address area, which stores an address that a usual address register has, and a range information storing area corresponding to the address.

It is supposed that the command-processing unit 1 can process an instruction operable to load-and-store the extended pointer type by one instruction to the address register 2.

Due to the loading-and-storing by one instruction, the address and the range information is not separated by interruption, rather they can be treated atomically.

Therefore, (Problem b) can be solved.

An illegal access-detecting unit 3 in FIG. 1 comprises a comparator. When the command-processing unit 1 accesses the memory 7 using a pointer relating to the address register 2, the illegal access-detecting unit 3 inputs the address fed by the command-processing unit 1 (a logical address value in the present example) and the range information of the address register 2, and performs comparison between them.

The illegal access-detecting unit 3 outputs an exception signal to the command-processing unit 1 when range violation of the memory 7 is found.

The access to the memory 7 may be performed by direct addressing or indirect addressing that performs addition and subtraction of an index value.

The present processor architecture can deal with the pointer at high speed and atomically by one machine instruction while performing a range check, since the range information is inseparably related to the pointer. In other words, the illegal access can be detected without increase in software processing; thereby, (Problem b) can be solved.

The program itself can even generate the exception signal without help of a program that operates by the execution mode of the processor such as an OS, and can trap unsuitable memory access.

A program counter 9 is written and read by the command-processing unit 1 and stores an execution address value in the program. The command-processing unit 1 stores a new execution address value into the program counter 9 by one machine instruction.

The above processing is performed when the execution address value of the program counter 9 is incremented or when branch instruction such as JUMP or CALL instructions are performed.

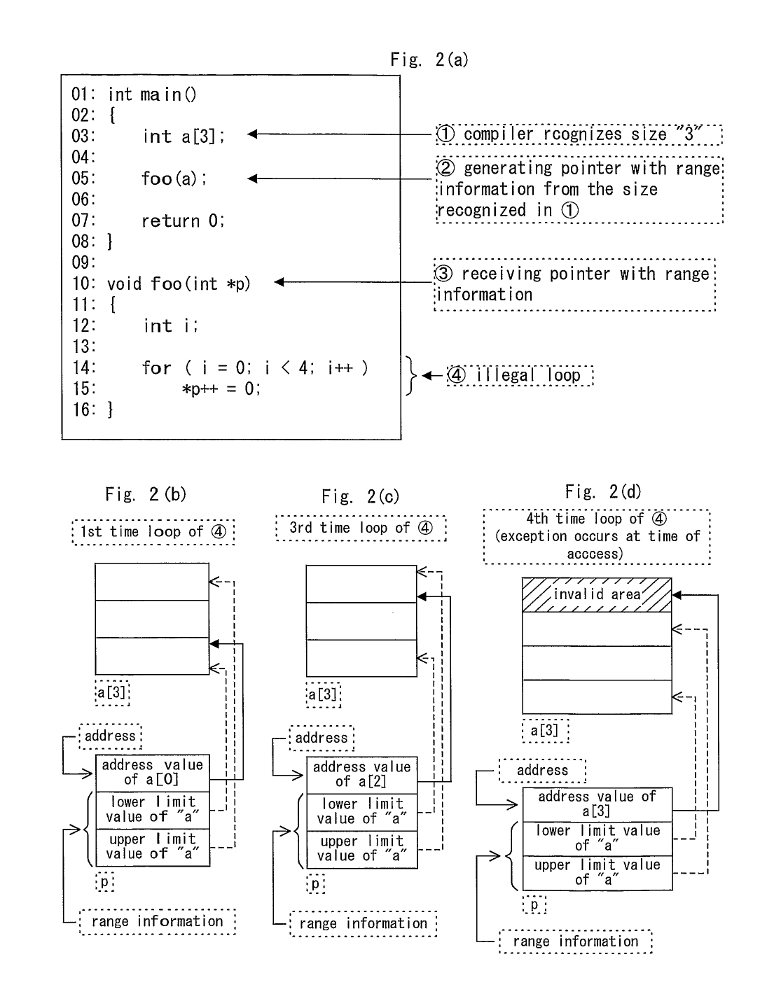

Next, the process of the error detection by the structure described above is explained referring to FIG. 2.

In a source code of FIG. 2 (a), a function “main” passes the pointer of the array “a” having only three int-typed variables in size to a function “foo”, and the function “foo” tries to write data of 4 bytes that exceeds a buffer.

First, the compiler recognizes that the size of the array “a” is “3”, when compiling the 3rd line of the source code of FIG. 2 (a). Next, in the fifth line of the source code, the complier generates a pointer indicating the array “a”, and then generates a code to be passed to the function “foo” as a parameter. The compiler generates the pointer that includes not only the address of the array “a”, but also the range information (a higher limit address and a lower limit address), which indicates the memory range assigned to the array “a”.

During the execution of the compiled code, at the time of the execution of a code corresponding to the fourth loop in a “for loop” of the function “foo” (the 14th line of the source code, when i=4), the pointer P tries to access the array “a”, exceeding the range, as shown in FIG. 2 (d),

In this case, since the pointer information includes the range information and the address register 2 stores the range information, the illegal access-detecting unit 3 detects illegal access, and outputs an exception signal to the command-processing unit 1. Therefore, it is possible to detect access exceeding the range.

(Condition 1), (Condition 2), and (Condition 4) are satisfied by the above-mentioned structures. Therefore, failure recovering information is further added to a pointer type using a compiler in order to solve the remaining (Condition 3) in the present invention. The principle of the addition is explained in the following.

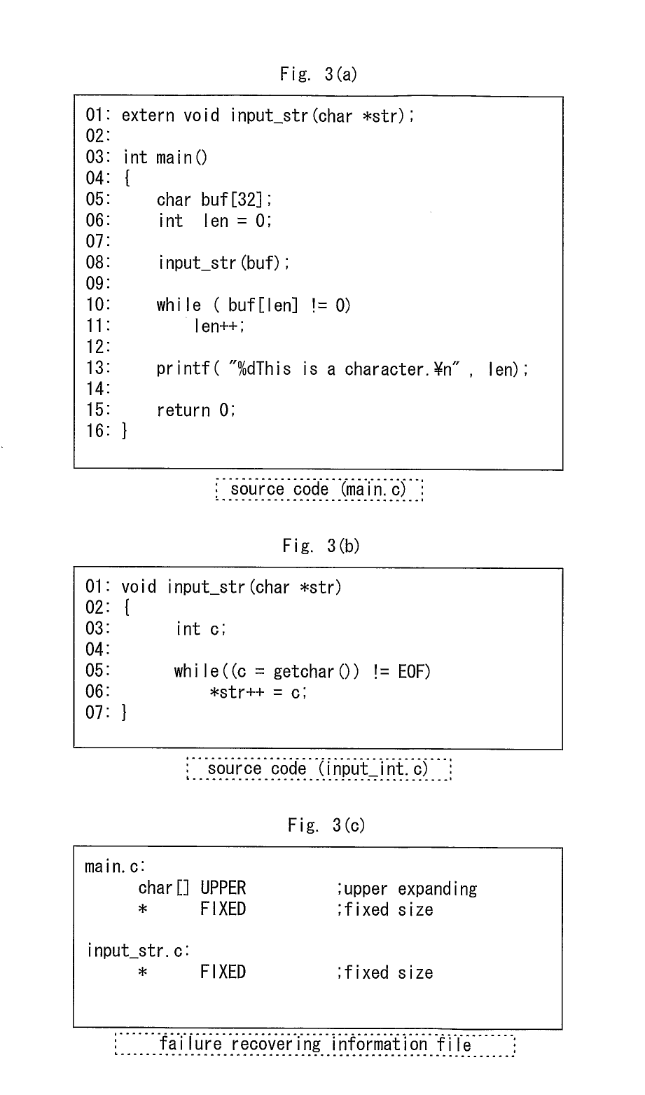

The source files shown in FIGS. 3(a) and 3(b), and the failure recovering information file shown in FIG. 3 (c) are taken as examples.

In the 8th line of the source file of FIG. 3 (a), the function “main” calls a function “input_str” defined as shown in FIG. 3 (b), and acquires a character string to the array “buf”. Then, the function “main” counts the string length of array “buf” in the 10th line to the 11th line, and outputs the result to a standard output in the 13th line.

In the stage of compiling, a failure recovering information file as shown in FIG. 3 (c) is prepared in addition to the source code. The failure recovering information file specifies such an object name, a data type, and a variable name, and the attribute for a failure recovering is added to data on the source code. Compiling means a series of process which outputs an execution code from a source, including preprocessing and link (etc. in a wide meaning.

The failure recovering information file shown in FIG. 3 (c) is different existence from the original source code itself. Since the failure recovering information file is evaluated by the compiler, it is existence similar to a compiler pseudo-instruction and a macro.

In the failure information file shown in FIG. 3 (c), an upper expanding attribute (UPPER) is added to a “char-typed array” within “main.c” (FIG. 3 (a)). The present embodiment also deals with a lower expanding attribute (LOWER) and a fixed size (FIXED).

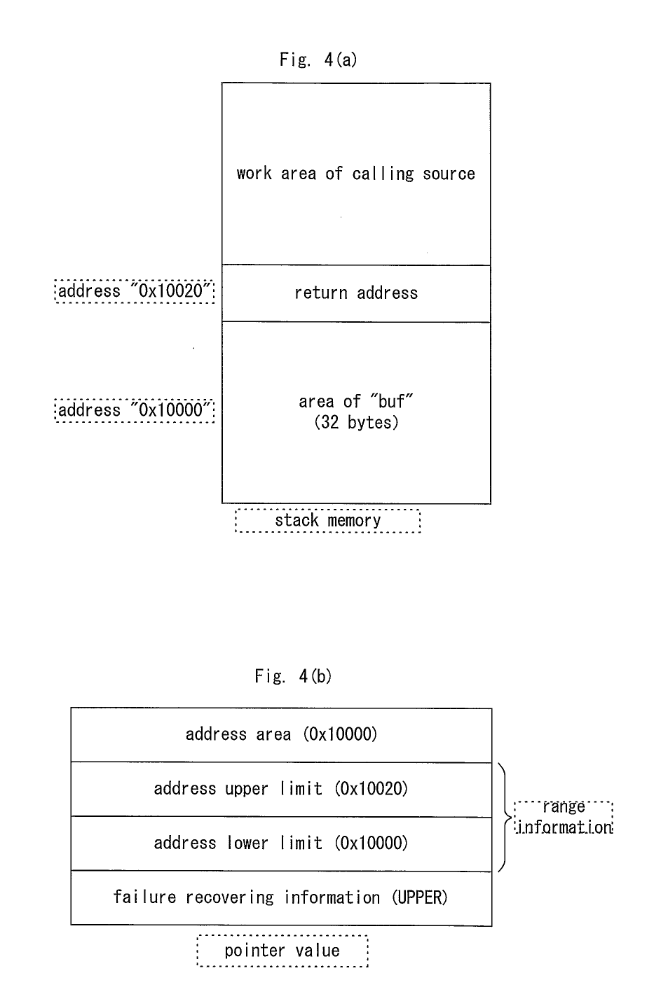

FIG. 4 (a) shows the contents of the stack memory when the function “main” calls the function “inputstr”, and FIG. 4 (b) shows the data structure of the pointer that is passed as arguments.

At the time of function calling, a pointer indicating the array “buf” is generated. The generated pointer type includes not only the address of the array “buf”, but also the range information (address upper limit and address lower limit) and the failure recovering information (UPPER).

The char-typed array “buf” is variables that are obtained by the function “main” in the stack memory as shown in FIG. 4 (a). Since the range information is passed by the pointer shown in FIG. 4 (b), the function “input_str” can properly supervise memory access range violation.

When data of greater than 32 bytes is inputted in the function “inputstr”, as exceptional data from a design point of view, a “while loop” in the fifth line of the source code shown in FIG. 3(b) is performed more than 32 times, then, illegal access occurs at the access of the sixth line of the source code shown in FIG. 3(b), and the illegal access-detecting unit 3 outputs an exception signal to the command-processing unit 1.

A command of an error occurrence location can be found by preparing an exception handler that is executable by the command-processing unit 1, and finding out a return address of the illegal access.

Analyzing the command can specify whether the illegal access operation is of write access or read access, and also the program address at the time of the command execution. Furthermore, the address, the range information and the failure recovering information at the time of the illegal access can be acquired from the address register 2.

Next, the failure recovering information is checked. In the example of FIG. 4 (b), the failure recovering information is an upper expanding attribute (UPPER), and judged as the data-type which stores variable-length data extending to the upper of the address. Therefore, it is sufficient to check whether or not the address of the illegal access is the upper of the range information.

In the present example, since the illegal access is found at the upper area, it is judged that buffer overrun has occurred.

Also in the present example, the access type is of write access, the failure-recovering process preferably returns to an address next to the address where the access error occurred, and nullifies the writing.

According to the above-mentioned operation, the function “input_str” may be terminated without destroying any areas except the “buf” area of the stack memory shown in FIG. 4 (a).

In 10th line of the source code shown in FIG. 3(a), the function “main” executes the “while loop”, and searches “0”, which is a NUL-character (an example of terminated value).

When none of the NUL-characters is included in the first half 32 bytes of the data read out by the function “input_str”, the “while loop” is executed more than 32 times. Then, the access which exceeds the area of the array “buf” occurs; thus, the access violation occurs.

In this case, what is necessary is executing the exception processing in the same manner as in write access. What is different from the previous case is only that the violation has occurred in read access.

The failure recovering processing in read access is performed as follows. The result obtained by the read access that has caused the exception is substituted by storing a terminated value “0”, and the execution flow is returned to a command next to the read access command.

By this processing, the “while loop” can be terminated without destroying any areas except “buf” area of the stack memory shown in FIG. 4 (a), because the terminating condition of the “while loop” of function “main” is satisfied.

According to the present consideration, the failure recovering of the program can be successfully performed against an attack or a bug, which, in the prior art, has caused system crack or forced termination at best with the help of successful error detection. Furthermore, the failure recovering of the program can be performed in a case where a bug is intentionally embedded in the source code itself for the purpose of permitting buffer overflow.

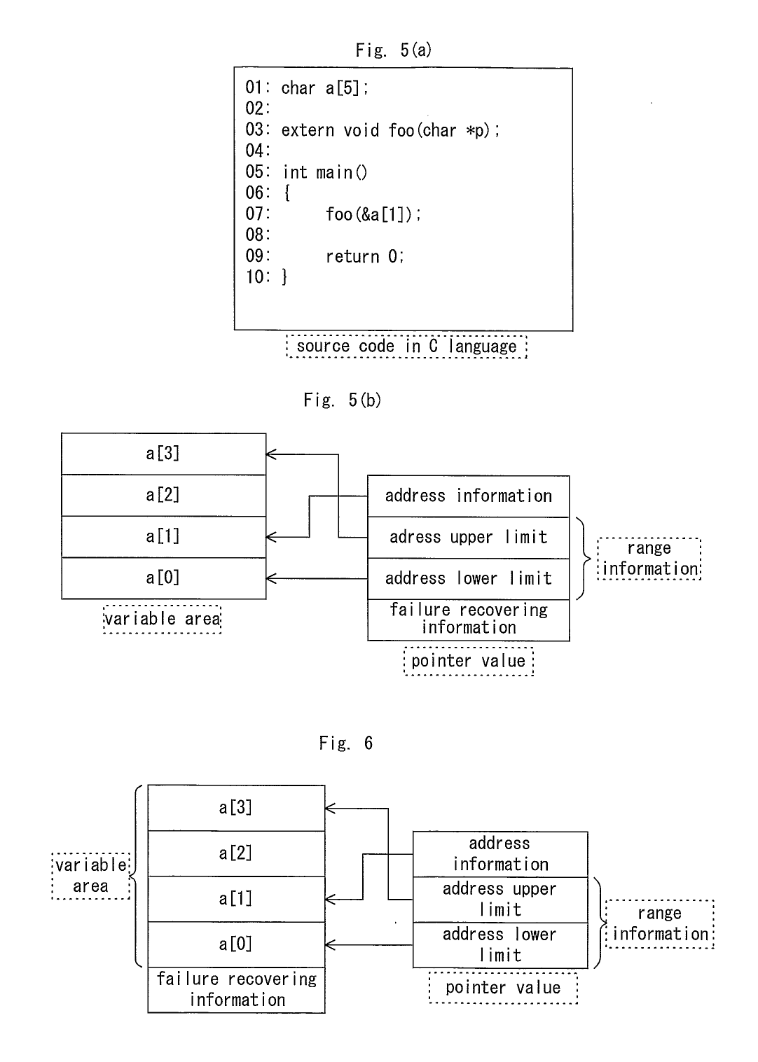

In the examples described so far, the pointer is furnished with the failure recovering information. In other words, when parameter is passed over in the 7th line of the source code shown in FIG. 5 (a), it is designed that the pointer value holds the failure recovering information as shown in FIG. 5 (b).

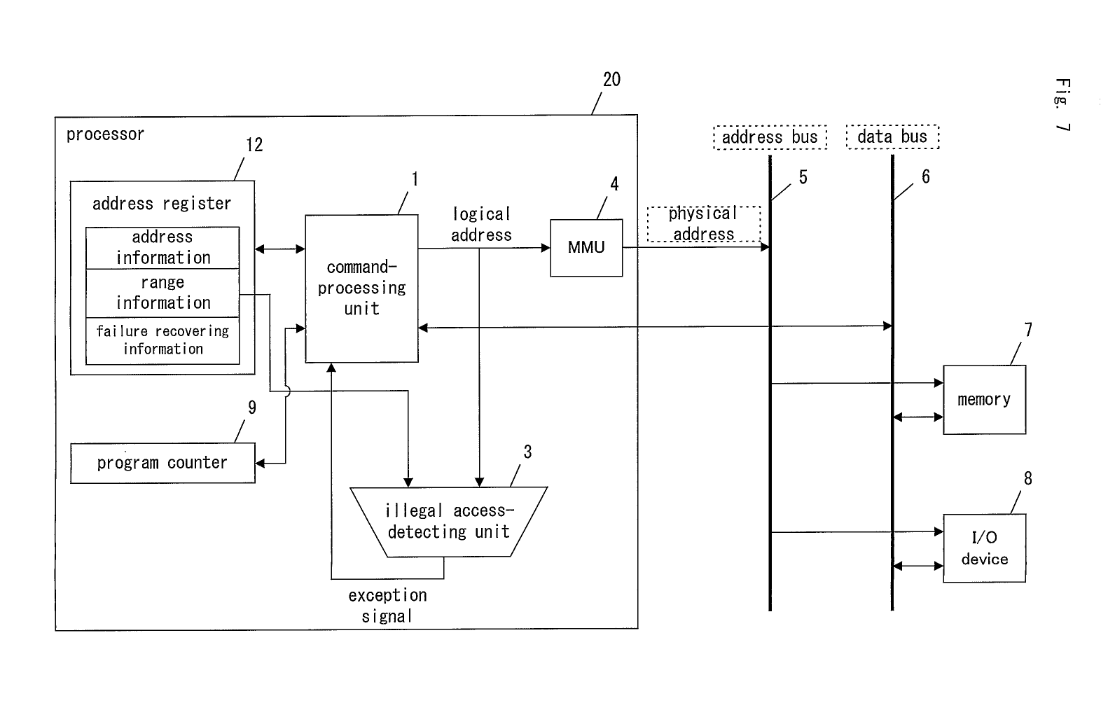

As a substitution for the scheme described above, the failure recovering information may be furnished to the array “a” itself that is declared by the 1st line of the source code of FIG. 5 (a). The failure recovering information adjoins the range of the array as shown in FIG. 6.

When the illegal access occurs under the substituted scheme mentioned above, since the range information can be acquired, the failure recovering information can be acquired by reading the address that is adjacent to the range information in a similar way as shown in FIG. 5 (b).

According to FIG. 5 (b), since the pointer is often used for parameter passing via the register, processing load of the parameter passing and the parameter receiving increases.

On the other hand, according to FIG. 6, since it is necessary to attach the failure recovering information to all the variables that may perform pointer access, the memory capacity for the pointer increases. However, processing amount of the pointer passing decreases. This is a merit.

The explanation of the consideration is completed.

Based on the above-mentioned consideration, the main point of the present invention is explained in the following.

(Main Point 1 of the Present Invention)

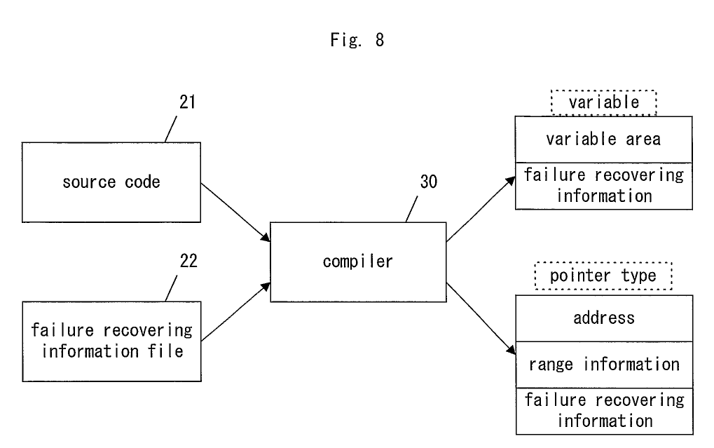

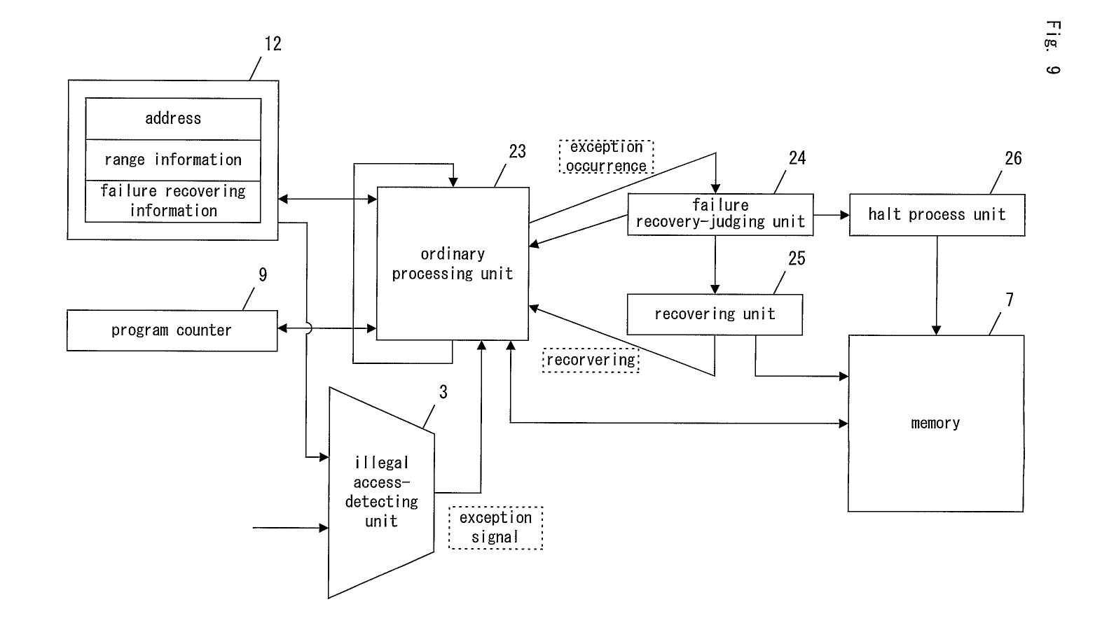

The main point 1 relates to the complier. The above-mentioned consideration leads to specific realization of a compiler as shown in FIG. 8.

A complier 30 reads a source code 21 (for example, refer to FIGS. 3 (a) and (b)) described with the programming language (for example, C/C++ language, Pascal, etc.) that can deal with a pointer, compiles the source code, and outputs an execution code. The meaning of “compile” here is as the consideration has described.

When the complier 30 compiles the source code 21, the compiler 30 refers to a failure recovering information file 22 (for example, FIG. 3 (c)). The recovering information is good enough if the compiler 30 can recognize its form. The recovering information does not have to be provided in the form of file all the time.

An important point is described next. The compiler 30 not only compiles the source code 21, but also performs either one of (Relationship 1) or (Relationship 2) as described in the following.

(Relationship 1): Regarding the pointer, the address of the pointer, the range information and the failure recovering information are inseparably related each other (referring to FIG. 5 (b)).

(Relationship 2): Regarding the pointer, the address of the pointer and the range information are inseparably related, and the failure recovering information is inseparably related to a variable that is operated by the pointer (referring to FIG. 6).

(Main Point 2 of the Present Invention)

The main point 2 relates to an information-processing apparatus. More specifically, the information-processing apparatus comprises a processor shown in FIG. 7, and the processor executes an execution code, which the compile device 30 in the main point 1 of the present invention has generated.

FIG. 7 is a block diagram of the processor in the main point 2 of the present invention.

An address register 12 of a processor 20 can store address information, range information, and failure recovering information.

The command-processing unit 1 interprets and executes the program code that is read from the memory 7. The command-processing unit 1 also can execute a command, which stores and loads to the address register 12 the pointer-type consisting of a set of the address information, the range information and the failure recovering information in the memory 7.

The processor 20 comprises the illegal access-detecting unit 3. When the command-processing unit 1 uses an addressing instruction that uses the address information of the address register 12, the illegal access-detecting unit 3 compares a logical address, which the command-processing unit 1 outputs, and the range information of the address register. Then, when the logical address to be accessed is beyond the range, the illegal access-detecting unit 3 outputs an exception signal to the command-processing unit 1.

The command-processing unit 1, upon receiving the exception signal, branches the execution to the execution address for the exception processing.

The processor 20 can perform the error detection at a high speed, without dividing operation of the address information, the range information, and the failure recovering information, which the pointer holds, by the interruption processing, thereby avoiding inconsistency in ordinary execution.

FIG. 9 is a functional block diagram showing the information-processing apparatus of the present invention.

An ordinary processing unit 23 reads a program that is stored in the memory 7, and performs the ordinary processing while updating the address register 12 and the program counter 9.

When the ordinary processing unit 23 inputs an exception signal from the illegal access-detecting unit 3, a failure recovery-judging unit 24 is called. Then the failure recovery-judging unit 24 refers to the failure recovering information in the address register 12, and judges if the failure recovering is possible.

When the failure recovery-judging unit 24 decides that the failure recovering is possible, the failure recovery-judging unit 24 calls a recovering unit 25. Then the recovering 25 performs the failure recovering processing based on the level of the failure, and returns the execution flow to the ordinary processing unit 23. At the same time, the ordinary processing unit 23 continues the ordinary processing, and the information-processing apparatus does not stop.

When the failure recovery-judging unit 24 decides that failure recovering is impossible, the failure recovery-judging unit 24 calls a halt process unit 26. Then the halt process unit 26 performs the halt process, and returns the execution flow to the ordinary processing unit 23. At this time, the ordinary processing unit 23 does not continue the ordinary processing, and the information-processing apparatus stops.

The ordinary processing unit 23, the failure recovery-judging unit 24, the recovering unit 25, and the halt process unit 26 shown in FIG. 6 are realized by the execution of the program in the memory 7 by the command-processing unit 1 shown in FIG. 7.

### FIRST EMBODIMENT

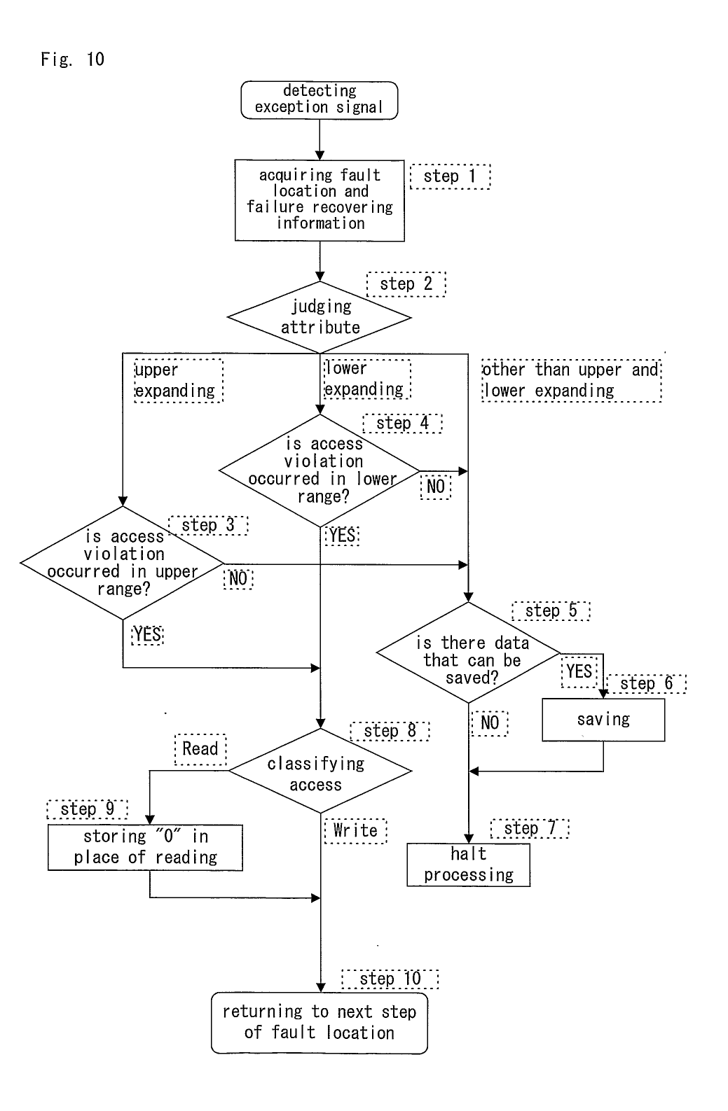

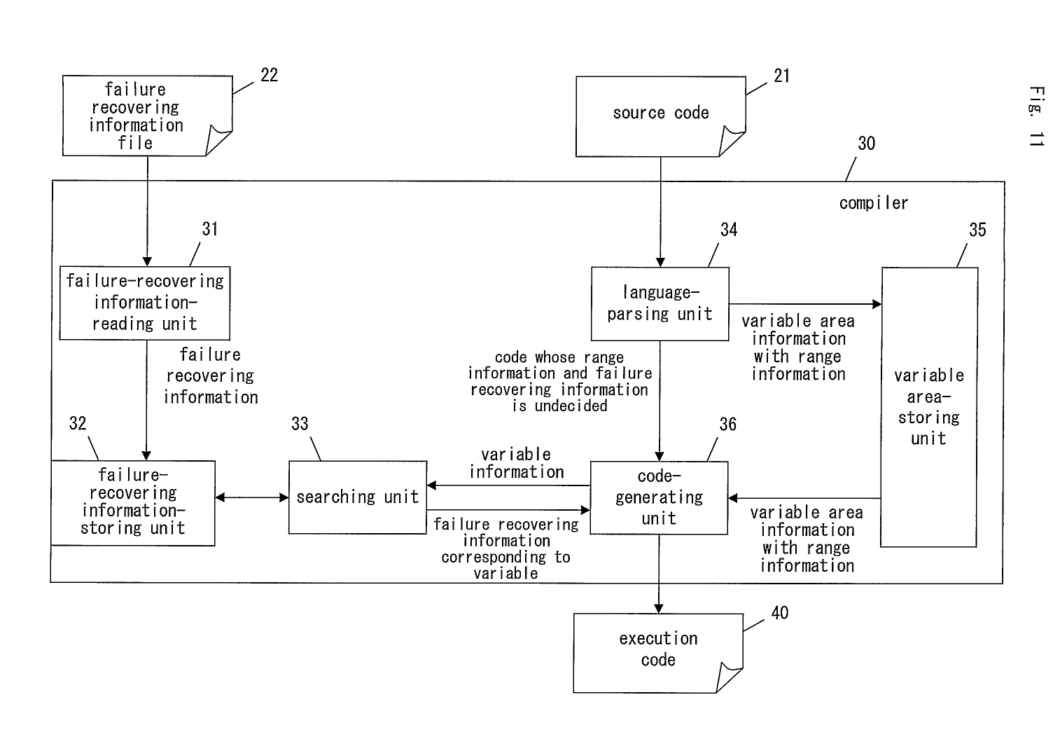

FIG. 10 is a flowchart of an information-processing apparatus according to a first embodiment of the present invention.

Hereinafter, with reference to FIGS. 9 and 10, processing after the ordinary-processing unit 23 inputs an exception signal from the illegal access-detecting unit 3 is described.

First, in step 1, the failure recovery-judging unit 24 acquires a value of the program counter 9 at the time of exception occurrence from the ordinary-processing unit 23, and acquires a command at the address where the illegal access has occurred.

The acquired command must be a command that performs memory access, and can uniquely specify information concerning whether the acquired command is reading or writing, and which address register the acquired command has used.

Since pointer information is stored in the address register 12, the failure recovery-judging unit 24 can acquire range information and failure recovering information of data that should be accessed originally.

Next, in step 2, the failure recovery-judging unit 24 checks the acquired failure recovering information.

In the present explanation, an upper expanding attribute (UPPER), a lower expanding attribute (LOWER), and a fixed size attribute (FIXED) are illustrated as the failure recovering information. However, it is also possible to use other attributes and prepare a recovering method corresponding to the data attributes.

When the failure recovering information is judged as the upper expanding attribute (UPPER) in step 2, the failure recovery-judging unit 24 checks whether illegal access is performed in the upper part of the data range in step 3.

When the illegal access is not performed in an upper part of the address, the failure recovery-judging unit 24 judges that failure recovery is not possible, and the halt processing unit 26 is called. At step 6, the halt-processing unit 26 saves data that can be saved in the memory 7 (step 6), and the ordinary-processing unit 23 stops the system (step 7).

When the illegal access is performed in an upper part of the address, the failure recovery-judging unit 24 judges as a buffer overflow (failure recovery is available), and calls the recovering unit 25 to try a recovery. The recovering unit 25 checks the access type at step 8. When the access type is of write access, the command is canceled, and when the command type is of read access, a terminated value (for example, “0”) is read as a fixed value at step 9. The ordinary-processing unit 23 returns to the next step of the failure location (step 10).

When the failure recovering information is judged as the lower expanding attribute (LOWER) in step 2, the failure recovery-judging unit 24 checks whether illegal access is performed in the lower part of the data range in step 4.

When the illegal access is not performed in a lower part of the address, the failure recovery-judging unit 24 judges that failure recovery is not possible, and the recovering unit 25 is called. At step 6, the halt-processing unit 26 saves data that can be saved in the memory 7 (step 6), and the ordinary-processing unit 23 stops the system (step 7).

When the illegal access is performed in the lower part of the address, the failure recovery-judging unit 24 judges as a buffer overflow (failure recovery is available), and calls the recovering unit 25 to try a recovery. The recovering unit 25 checks the access type at step 8. When the access type is of write access, the command is canceled, and when the command type is of read access, a terminated value (for example, “0”) is read as a fixed value at step 9. The ordinary-processing unit 23 returns to the next step of the failure location (step 10).

In step 2, when the failure recovering information is judged as (FIXED) that is neither the upper expanding attribute nor the lower expanding attribute, the failure recovery-judging unit 24 judges that failure recovery is not possible, and calls the recovering unit 25. At step 6, the halt-processing unit 26 saves data that can be saved in the memory 7 (step 6), and the ordinary-processing unit 23 stops the system (step 7).

### Effect of the First Embodiment

By processing an illegal access exception as described above, continuation of processing is enabled without destroying unrelated data in the writing processing beyond the range of data, and data can be read safely without reading unrelated data in the read processing beyond the range of the data.

FIG. 11 is a block diagram illustrating a function of a compiler according to the first embodiment of the present invention.

The source code 21 is inputted into a language-parsing unit 34, and the language-parsing unit 34 translates the source code 21 into an execution code. Here, the language-parsing unit 34 allocates a code in which an address to a variable, range information, and failure recovering information are to be included in pointer generation. However, a value to be stored is remained undecided.

The language-parsing unit 34 writes and saves the address and the range information of an area that are allotted to the variable at a variable area-storing unit 35 when a variable declaration part is found.

The translated execution code is transmitted to a code-generating unit 36.

A failure-recovering information-reading unit 31 reads information from the failure recovering information file 22 that is different from the source code 21, and stores the information in a failure-recovering information-storing unit 32.

Regarding the undecided-position value inside the pointer among the execution codes outputted from the language-parsing unit 34, the code-generating unit 36 reads a variable address and range information from the variable area-storing unit 35, and stores the variable and the range information into the undecided-position value.

The code-generating unit 36 sends the variable information that the pointer points out to a searching unit 33. The searching unit 33 searches inside the failure-recovering information-storing unit 32 according to the inputted variable information, and outputs failure recovering information corresponding to the variable to the code-generating unit 36. The code-generating unit 36 writes into the pointer in the code the failure recovering information as a search result obtained from the searching unit 33.

Thereby, the code-generating unit 36 outputs an execution code 40 that the variable address, the range information and the failure recovering information are stored in the pointer part.

The execution code that the failure recovering information is embedded is generated from the source code 21 by the present compiler. When the generated execution code is installed in information equipment, the information equipment can obtain a failure-recovering function.

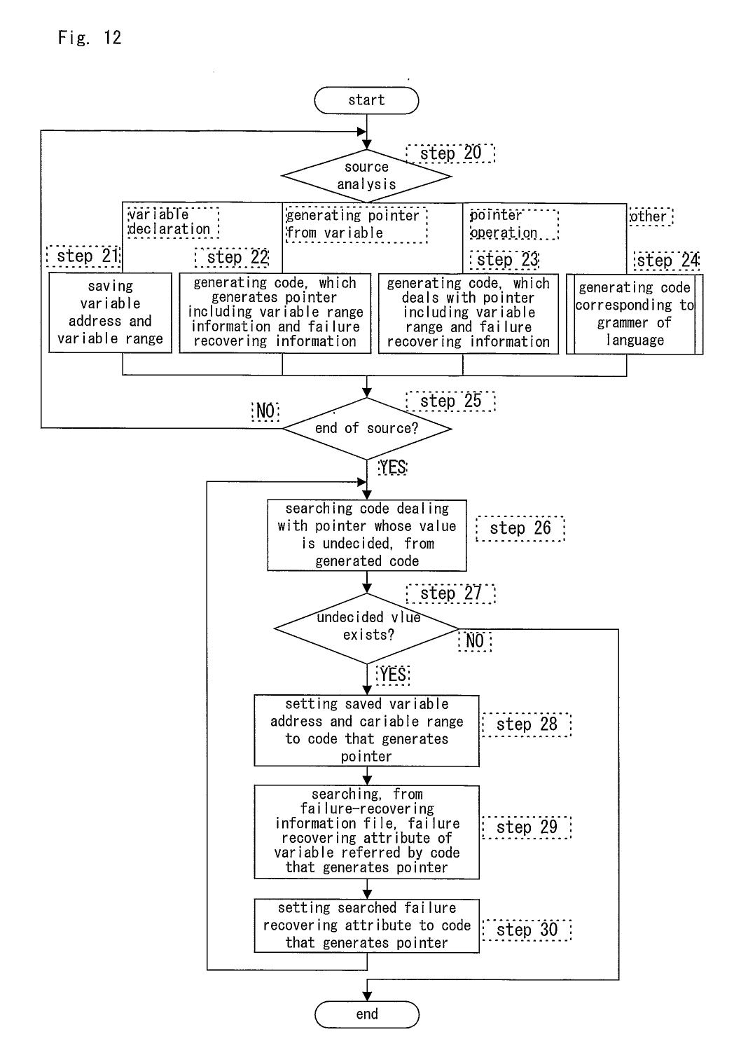

FIG. 12 is a flowchart of a compiler according to the first embodiment of the present invention.

In step 20, the language-parsing unit 34 performs source analysis one after another from the top of the source code 21.

When the result of the source analysis in step 20 is variable declaration, the language-parsing unit 34 allocates an area for variables, and saves the information in the variable area-storing unit 35 at step 21.

When the result of the source analysis in step 20 is a command that is to generate a pointer from the variable, the language-parsing unit 34 generates a code that generates a value including an address of the variable, range information of the variable and failure recovering information as a pointer value at step 22.

Here, since the value in the pointer is not decided, the language-parsing unit 34 generates a code with an undecided value.

When the result of the source analysis in step 20 is a pointer operation, the language-parsing unit 34 calculates only an address value in the pointer, and generates a code that copies the range information and the failure recovering information as they are at step 23.

When the result of the source analysis in step 20 is other than the above, the language-parsing unit 34 generates a code corresponding to the language like a regular compiler at step 24.

After the language-parsing unit 34 repeats such procedure to the source code end (step 25), the code-generating unit 36 determines and stores address information and range information among the undecided pointer information in a code, from variable area information stored in the variable area-storing unit 35 (steps 26 through 28).

As the last processing, the code-generating unit 36 searches a pointer whose failure recovering information within the pointer information is undecided.

When the searching unit 33 searches a variable attribute from the failure-recovering information-storing unit 32 and detects a corresponding setting, the code-generating unit 36 stores the value. The variable attribute is of the variable that the pointer with the undecided failure recovering information pointes out. When the searching unit 33 does not detect the variable attribute, the searching unit 33 sets a fixed value, for example, an attribute indicating a fixed size (FIXED).

The above operation is repeated until the undecided value is used up (steps 26 through 30).

Here, a series of processing of generating an executable code from a source code is called “compile”. The “compile” may be divided into processing of compile in a narrow meaning or link.

### MODIFICATION OF THE FIRST EMBODIMENT

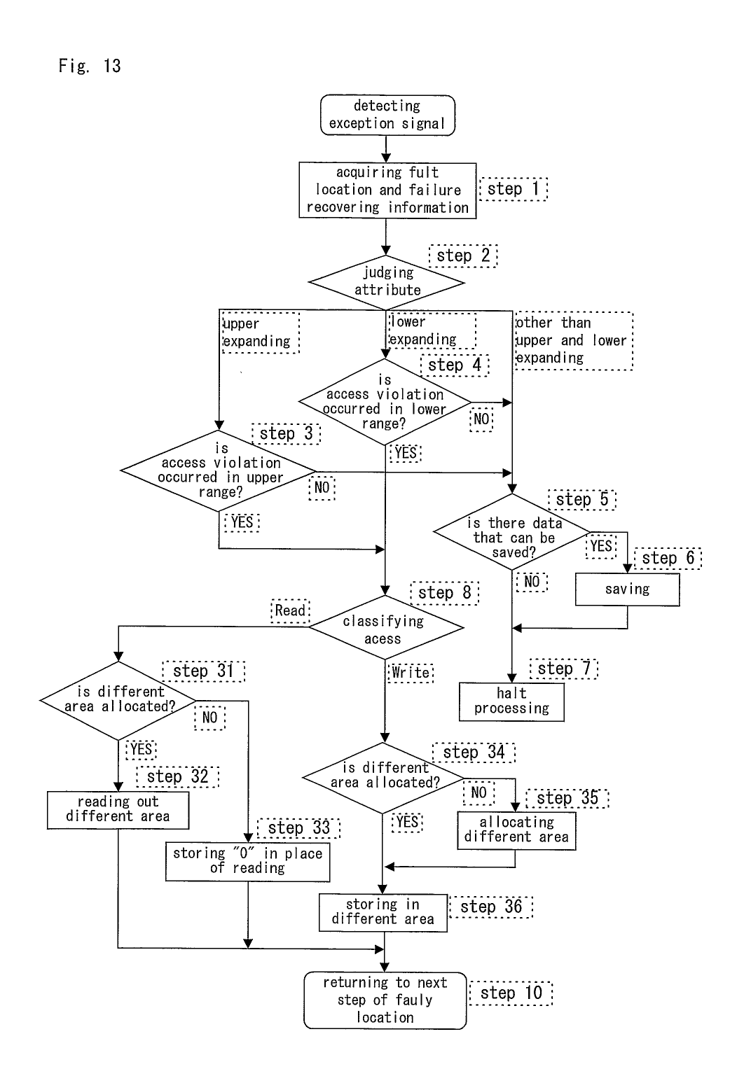

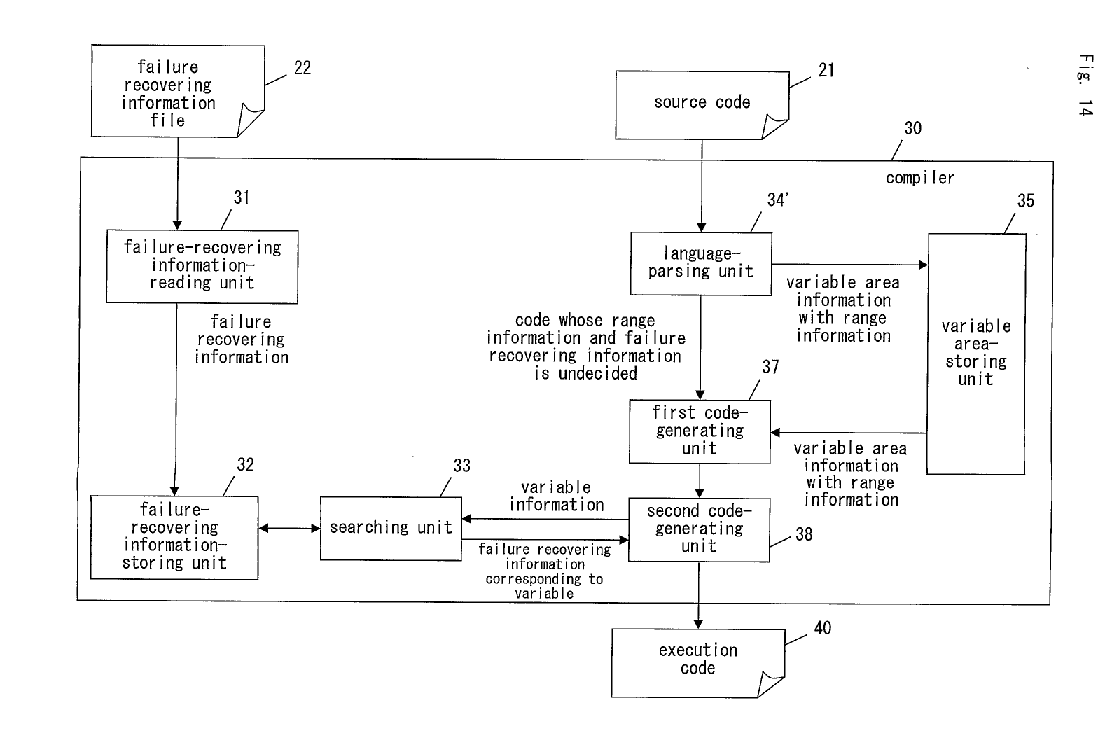

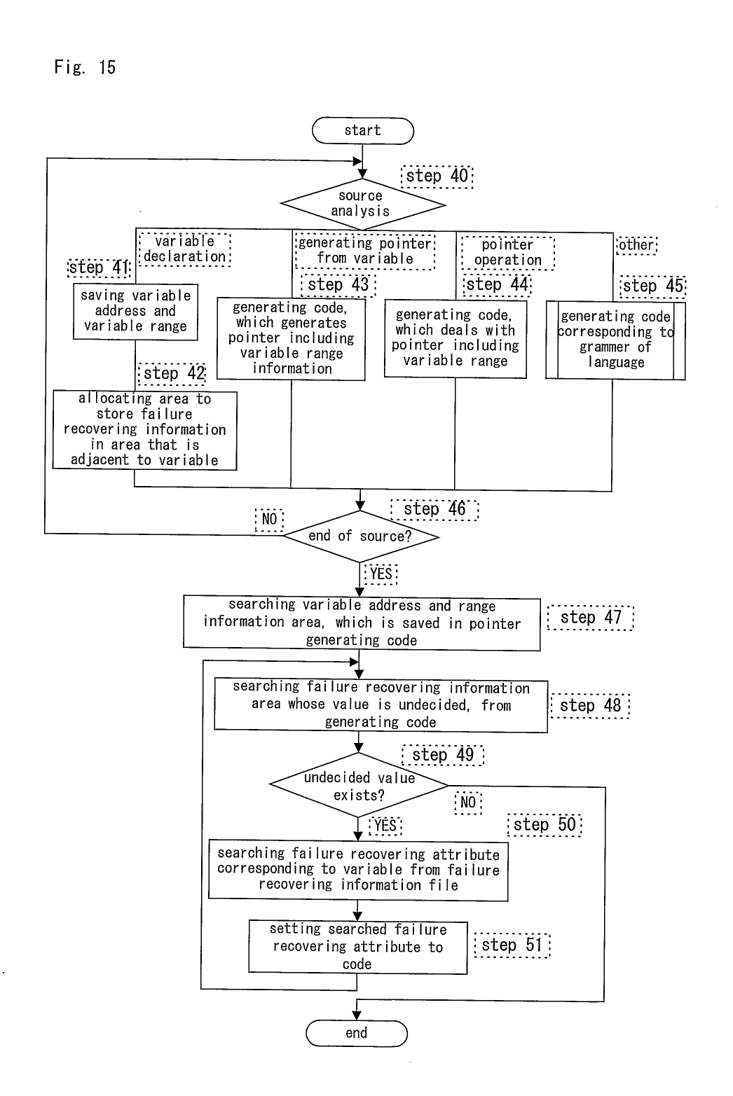

FIG. 13 is a flowchart with change that is added after step 8 of FIG. 10 (the contents of processing in the recovering unit 25 in FIG. 9.)

In order to avoid duplication of description, only the processing after step 8 is described.

At step 8, the recovering unit 25 checks an acess type. When the access type is of write access, the recovering unit 25 allocates to a memory the different area from the range of the data to be accessed, and writes to the allocated area the data that is to be written (step 34 through 36).

In step 31, when the access type is of read access, the recovering unit 25 checks if there exists an area that has already obtained data to be written at step 35. If the area exists, the recovering unit 25 reads a value of the area in step 32. If the area does not exist, the recovering unit 25 reads a terminated value (for example, “0”) as a fixed value in step 33.

### Effect of the Modification

Expanding the size of data in a writing processing beyond the range of data is enabled by processing an illegal access exception as described above. When an input size of data exceeds an estimated value, it becomes possible to recover the data that may cause system breakdown if the data is simply discarded.

### SECOND EMBODIMENT

FIG. 14 is a block diagram illustrating a function of a compiler according to a second embodiment of the present invention.

In FIG. 14, description is omitted by attaching the same symbols as the same components in FIG. 11 of the first embodiment.

According to the first embodiment, the pointer value has failure recovering information as illustrated in FIG. 5(b) (Relationship 1), whereas according to the second embodiment, a variable that a pointer operates is furnished with failure recovering information as illustrated in FIG. 6 (Relationship 2).

For the above-described reason, the code-generating unit 36 (referring to FIG. 11) in the first embodiment is divided into a first code-generating unit 37 and a second code-generating unit 38 as illustrated in FIG. 14. The contents of processing of a language-parsing unit 34′ are also changed.

When the language-parsing unit 34′ finds a variable declaration part in the source code 21, the language-parsing unit 34′ writes and saves in a variable area-storing unit 35 an address and range information of an area that are allotted to the variable. The language-parsing unit 34′ also allocates extra capacity for the failure recovering information in a place that is next to the variable area.

Thereby, the variable area shown in FIG. 6 is allocated

The first code-generating unit 37 reads from the variable area-storing unit 35, and stores the variable address and the range information into the value of the pointer that has remained as an undecided position in the execution code outputted from the language-parsing unit 34′.

The second code-generating unit 38 receives the execution code having the variable address and the range information in the pointer, both outputted from the first code-generating unit 37. Then, the second code-generating unit 38 sends the variable information to the searching unit 33 one after another and stores failure recovering information in an area that is next to the variable information. The failure recovering information is a search result obtained from the searching unit 33.

The other points in processing are the same as in the first embodiment.

FIG. 15 is a flowchart of a compiler according to the second embodiment of the present invention.

At step 40, the language-parsing unit 34′ performs source analysis one after another from the top of the source code 21.

When the result of the source analysis in step 40 is a variable declaration, the language-parsing unit 34′ allocates an area for variable and another area for the failure recovering information next to the area for variable, and saves the information (steps 41 and 42).

When the result of the source analysis in step 40 is a command that is to generate a pointer from the variable, the language-parsing unit 34′ generates a code that generates a value including an address of the variable, range information of the variable and failure recovering information as a pointer value at step 43.

Since the value in the pointer is not decided here, the language-parsing unit 34′ generates a code with an undecided value.

When the result of the source analysis in step 40 is pointer operation, the language-parsing unit 34′ calculates only an address value in the pointer, and generates a code that copies the range information and the failure recovering information as they are at step 44.

When the result of the source analysis in step 40 is other that the above, the language-parsing unit 34′ generates a code corresponding to the language like the prior compiler at step 45.

After the language-parsing unit 34′ repeats such procedure to the source code end (step 46), the first code-generating unit 37 determines, at step 47, address information and range information from the variable area information saved, and stores them into the undecided pointer information in the code.

As the last processing, the second code-generating unit 38 searches a pointer whose failure recovering information is undecided within the information attached to the data information.

When the searching unit 33 searches a variable attribute from the failure-recovering information-storing unit 32 and detects a corresponding setting, the second code-generating unit 38 stores the value. The variable attribute is of variable that the pointer with the undecided failure recovering information points out. When the searching unit 33 does not detect the variable attribute, the searching unit 33 sets a fixed value, for example, an attribute indicating a fixed size (FIXED).

The above operation is repeated until the undecided value is used up (steps 48 through 51).

Here, a series of processing of generating an executable code from a source code are called “compile”. The “compile” may be divided into processing of compile in a narrow meaning or link.

### THIRD EMBODIMENT

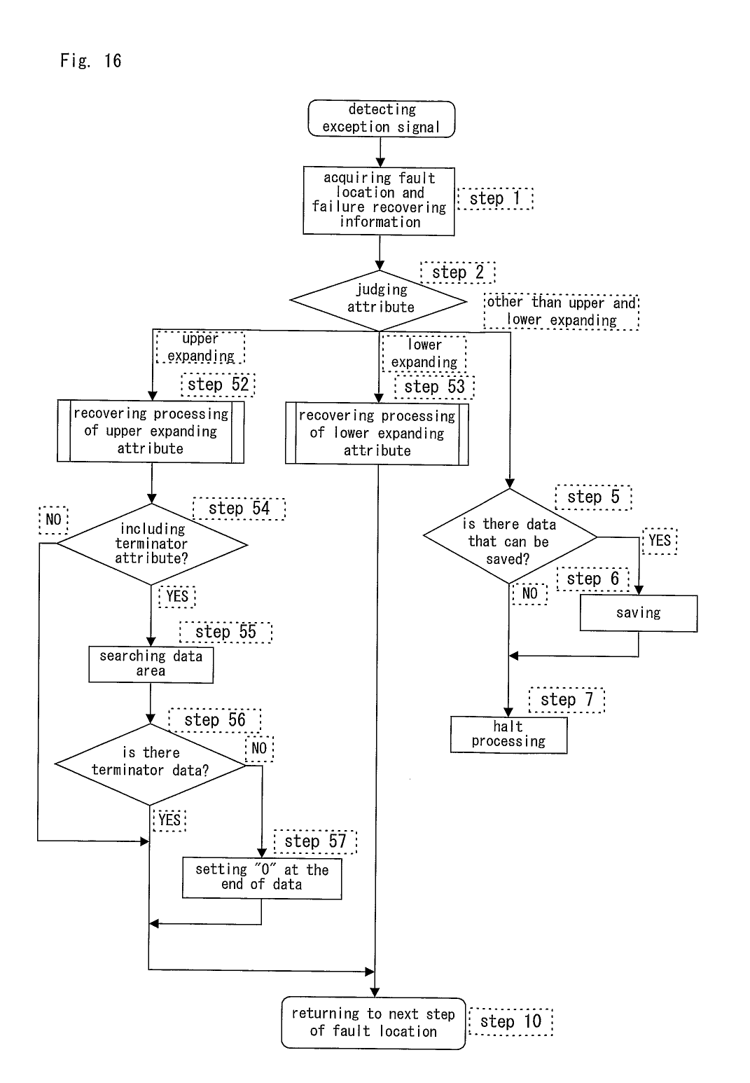

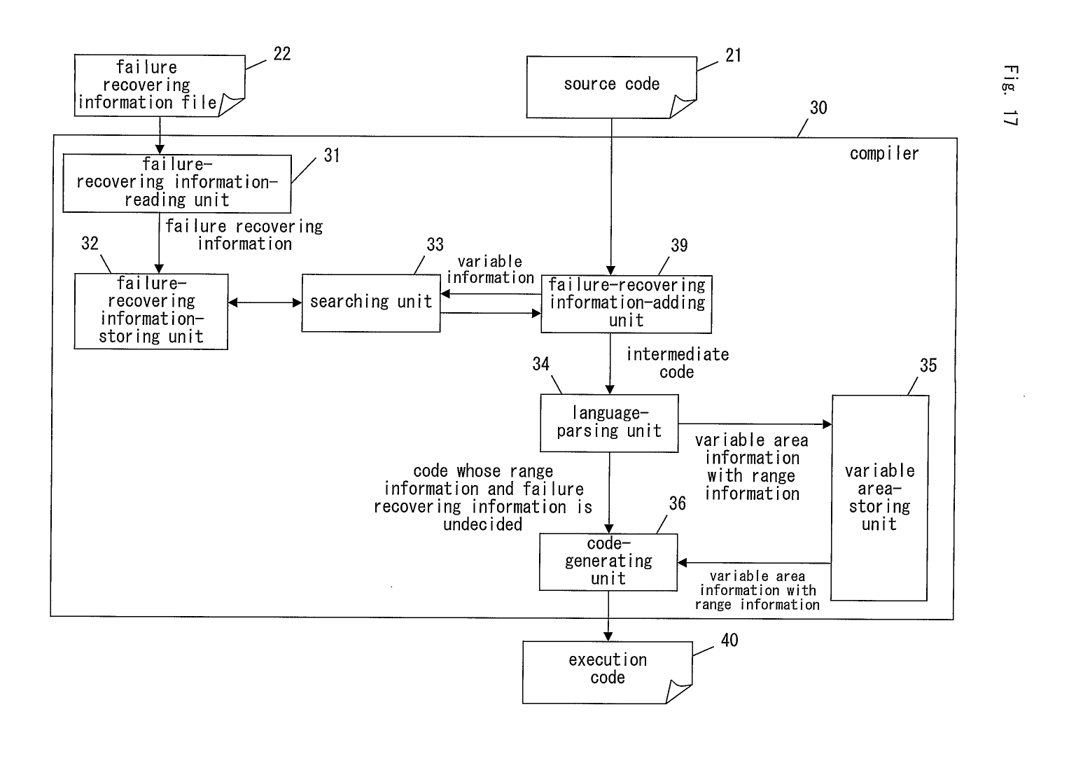

FIG. 16 is a flowchart of an information-processing apparatus according to a third embodiment of the present invention.

A block diagram illustrating a function according to the third embodiment is shown in FIG. 9, which is same as in the first embodiment.

Hereinafter, different points from the first embodiment are described.

In step 2, the failure recovery-judging unit 24 checks the acquired failure recovering information.

In the present explanation, an upper expanding attribute (UPPER), a lower expanding attribute (LOWER), and a fixed size attribute (FIXED) are illustrated as the failure recovering information. However, it is also possible to use the other attribute and prepare a recovering method corresponding to the data attribute.

When the failure recovering information is judged as the upper expanding attribute (UPPER) in step 2, the failure recovery-judging unit 24 performs a recovering processing of the upper expanding attribute at step 52 as in the first embodiment.

When a terminator attribute is furnished to data at step 54, the failure recovery-judging unit 24 searches whether terminator data exists in the data at step 55.

When the terminator data does not exist in the data at step 56, the failure recovery-judging unit 24 attaches terminator data (for example, “0”) to the tail of the data at step 57.

Thereby, the terminator data that has been lost can be restored, and reliability of data can be improved.

When the failure recovering information is judged as the lower expanding attribute (LOWER) at step 53, the failure recovery-judging unit 24 performs the same recovering processing as in the first embodiment. Even when the failure recovering information is judged as neither the upper expanding attribute nor the lower expanding attribute, but a fixed size attribute (FIXED), the failure recovery-judging unit 24 also performs the same recovering processing as in the first embodiment.

### Effect of the Third Embodiment

For example, in C language, data like a character string express the end of the data by adding a NUL character to the end of the data.

However, when data structure is destroyed because of illegal data etc., a NUL character does not exist in the data and a serious failure, such as rewriting an address of data that must not be accessed originally, is easily caused by the subsequent data operation.

According to the present embodiment, by formalizing compulsorily data structure like a character string into a formal form in case of failure occurrence, a secondary failure can be avoided from occurring.

### FOURTH EMBODIMENT

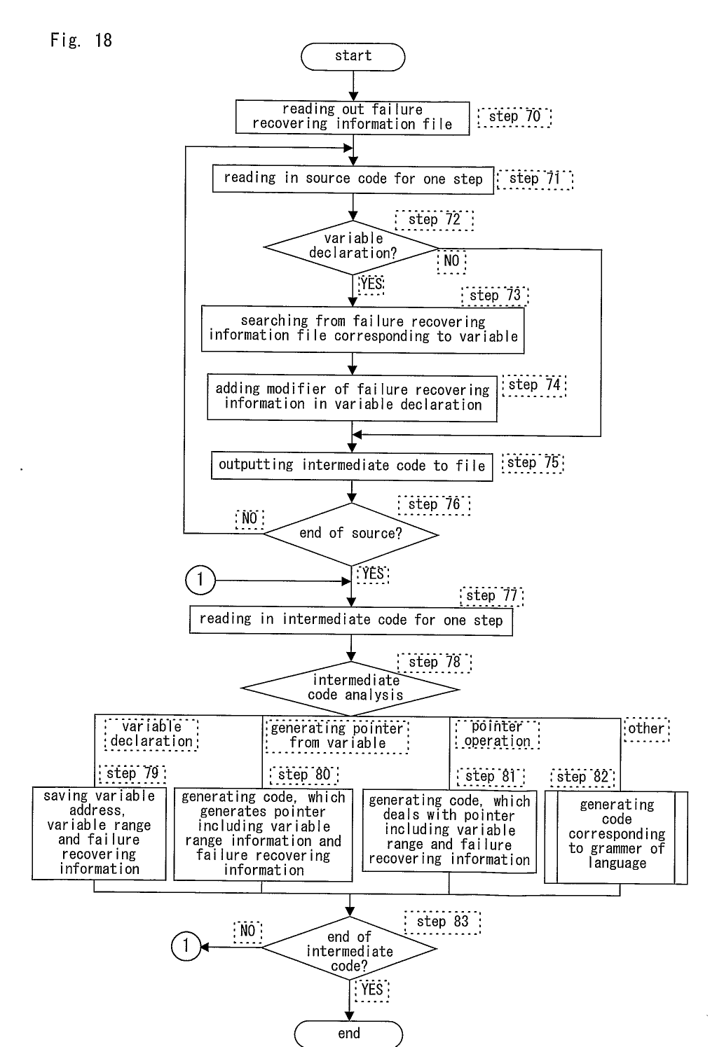

FIG. 17 is a block diagram illustrating a compiler according to a fourth embodiment of the present invention. FIG. 18 is a flowchart of the compiler according to the fourth embodiment of the present invention.

According to the first embodiment through the third embodiment, code-generating is performed without adding direct change to the source code 21.

In the present embodiment, information is added to the source code 21 to generate an intermediate code inside the compiler.

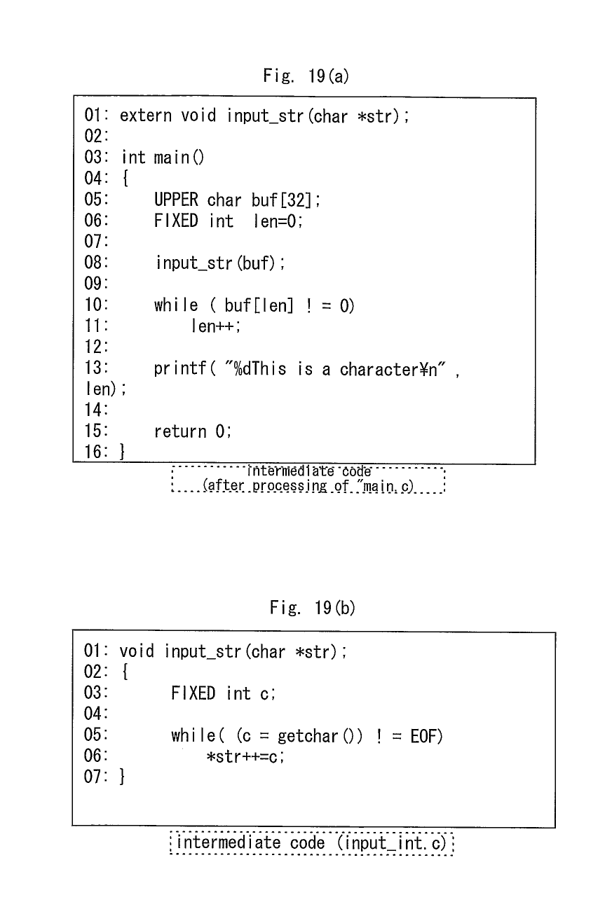

For example, when there is a source code shown in FIGS. 3 (a) and (b) and a failure recovering information file shown in FIG. 3 (c), an intermediate code of FIG. 19 (a) is generated based on the source code of FIG. 3 (a), and the intermediate code of FIG. 19 (b) is generated based on the source code of FIG. 3 (b).

Generating an intermediate code itself can be easily installed using a common-knowledge art such as replacing a character string.

Keywords of “UPPER” and “FIXED” are inserted in the fifth line and the sixth line of the intermediate code of FIG. 19 (a), and a keyword “FIXED” is inserted in the third line of the intermediate code of FIG. 19 (b).

In FIG. 17, a failure-recovering information-adding unit 39 inputs the source code 21, and generates an intermediate code that failure recovering information is added to the source code 21.

The rest of the points are the same as in the first embodiment.

The following point is to be noted. According to the first embodiment through the third embodiment and the present embodiment, even if the programmer does not edit the source code 21, failure recovering information can be added.

The above-described point is extremely effective when a great amount of source data exists, and the execution code compiled from the existent source data must be revised, as a whole, to a version that includes a failure-recovering function of the present invention.

Next, operation of the compiler of the present embodiment is described with reference to FIG. 18.

First, at step 70, the failure-recovering information-reading unit 31 reads the failure recovering information file 22, and sets failure recovering information to the failure-recovering information-storing unit 32.

Next, the failure-recovering information-adding unit 39 reads the source code 21 for one step (for example, one line etc.) at step 71, and checks at step 72 whether a variable declaration exists in the step.

When the variable declaration does not exist in the step, the processing moves to step 75.

When the variable declaration exists, at step 73, the failure-recovering information-adding unit 39 outputs variable information to the searching unit 33 and searches the failure recovering information of a variable that the variable information indicates.

When the failure recovering information exists, at step 74, the failure-recovering information-adding unit 39 adds the failure recovering information to the variable declaration, and the processing moves to step 75.

At step 75, the failure-recovering information-adding unit 39 outputs an intermediate code regarding the step to outside (for example, a certain area of a hard disk device etc.) as a temporary file.

At step 76, the failure-recovering information-adding unit 39 checks that the end of the source code 21 is not reached, and the processing of steps 71 through 76 is repeated until the end of the source code 21 is reached.

Accordingly, the intermediate code as shown in FIG. 19(a) and FIG. 19(b) is generated.

After the intermediate code is generated, a processing according to the first embodiment where “source code 21” is read as “intermediate code” is performed (steps 77 through 83).

The present embodiment also has the same effect as in the first embodiment.

### FIFTH EMBODIMENT

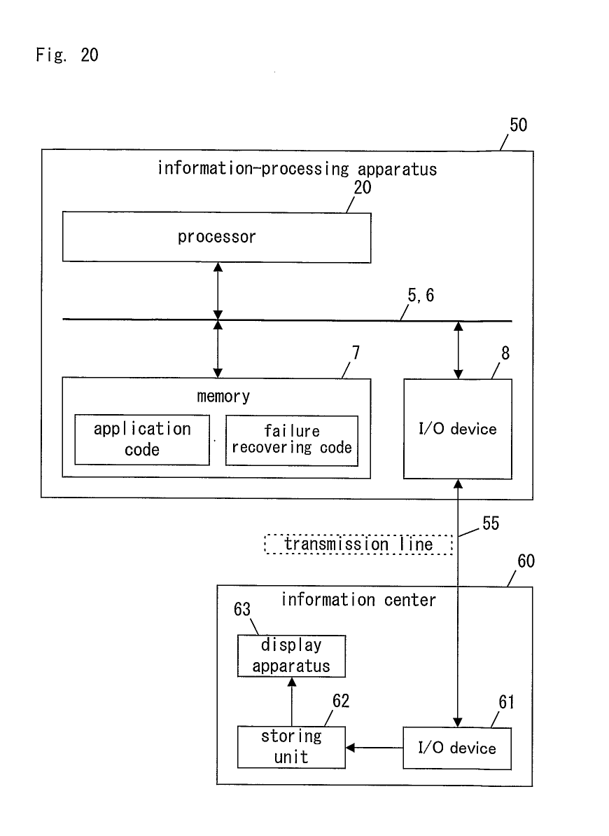

FIG. 20 is a block diagram illustrating a failure information-supervising system according to a fifth embodiment of the present invention.

An information-processing apparatus 50 comprises the processor 20, the address bus 5, the data bus 6, the memory 7 and the I/O device 8 that are illustrated in FIG. 7.

A program that has a function illustrated in FIG. 9 is loaded in the memory 7.

The program includes a failure-recovering code in addition to a regular application code.

The I/O device 8 connects with an I/O device 61 of an information center 60 via a transmission line 55.

The information center 60 includes the I/O device 61, a storing unit 62, and a display apparatus 63. The storing unit 62 records failure information, and the display apparatus 63 displays the failure information.

When a failure occurs in executing an application code in the information-processing apparatus 50, the processor 20 executes a failure-recovering code in the memory 7.

When the failure-recovering code is executed, information of the contents of the failure is transmitted to the information center 60 via the transmission line 55.

In the information center 60, the contents of the failure are recorded in the recording unit 62, and the display apparatus 63 displays the contents of the failure.

### Effect of the Fifth Embodiment

According to the above-described system structure, it becomes possible to collect failure information in the operation phase of an information-processing apparatus, such as a cellular phone that is sold to each user.

Accordingly, the collected failure information can be used for fixing a failure location in the next shipment lot of the information-processing apparatus, or for improving a development method to prevent a similar failure in other developments.

### SIXTH EMBODIMENT

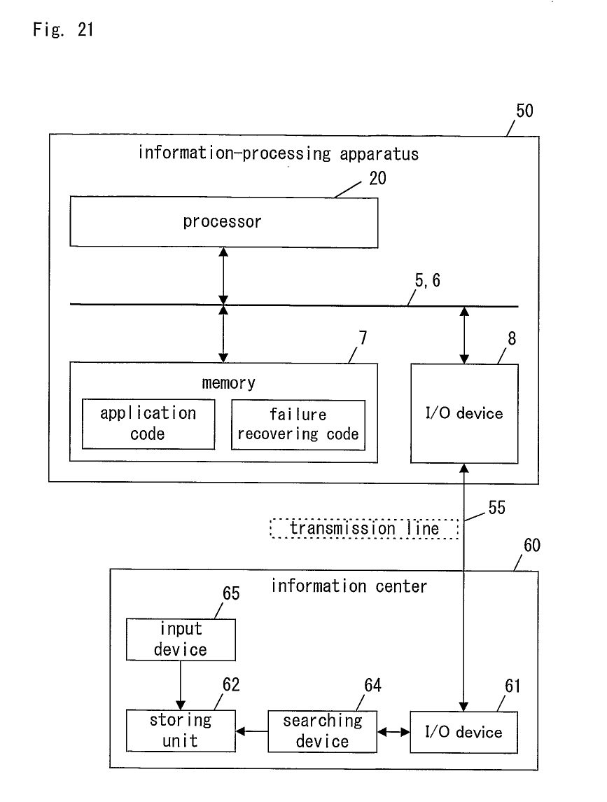

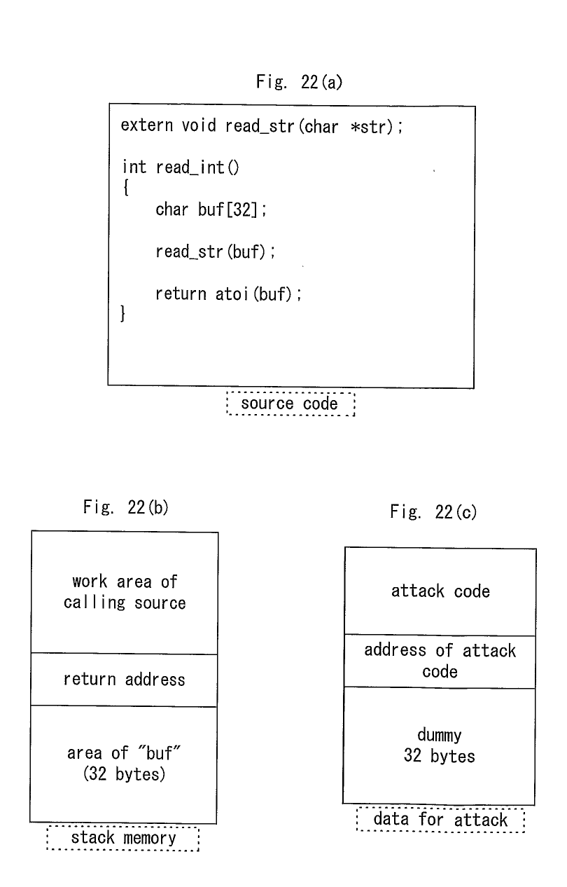

FIG. 21 is a block diagram illustrating a failure information-supervising system according to a sixth embodiment of the present invention.

The present embodiment adds change to the information center 60 of the fifth embodiment.

The information center 60 inputs information of a recovering method for a failure from an input device 65, and stores the information in a storing unit 62.

When a failure occurs in executing application in the information-processing apparatus 50, the processor 20 executes a failure-recovering code.

Thereby, information of the contents of the failure is transmitted to the information center 60 via the transmission line 55. In the information center 60, a searching device 64 searches the storing unit 62 and returns the information of the recovering method corresponding to the failure.

In the information-processing apparatus 50, a recovering process is performed according to the information of the returned recovering method.

### Effect of the Sixth Embodiment

According to the above-described system structure, it becomes possible to change a failure recovering means in the operation phase of an information-processing apparatus, such as a cellular phone that is sold to each user.

Even when a trouble occurs that cannot be dealt only with a failure-recovering unit installed in advance, registering a solution at the information-center side leads to a solution for the trouble.

According to the present invention, a failure-recovering function of an information-processing apparatus can be strengthened, and operation stability can be improved.

### INDUSTRIAL APPLICABILITY

The information-processing method according to the present invention is preferably applicable in the field of, e.g., security-required software development.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. An information-processing method, comprising:
relating range information and failure-recovering information to an address of a memory;
performing ordinary processes while detecting illegal access to the memory;
judging upon detection of the illegal access to the memory whether or not failure-recovering is possible based on the range information and the failure-recovering information; and
performing failure-recovering processes when the failure-recovering is possible.

2. The information-processing method as claimed in claim 1, further comprising: performing halt processes when the failure-recovering is not possible.

3. The information-processing method as claimed in claim 1, wherein the failure-recovering information includes items of a fixed size attribute and a variable size attribute.

4. The information-processing method as claimed in claim 3, wherein the variable size attribute includes an upper expanding attribute and a lower expanding attribute.

5. The information-processing method as claim 2, wherein said performing failure-recovering processes includes storing data if the data is storable.

6. The information-processing method as claimed in claim 1, wherein said performing failure-recovering processes includes:
judging whether an access type is of read access or of write access; and
performing failure-recovering whose content is different according to said judging.

7. The information-processing method as claimed in claim 6, wherein failure-recovering without a specific process is performed when the access type is of write access, and failure-recovering after storing a predetermined value into a current address of the memory is performed when the access type is of read access.

8. The information-processing method as claimed in claim 4, wherein said judging determines that the failure-recovering is not possible when the failure-recovering information indicates an upper expanding attribute and a downward illegal access to the memory is detected.

9. The information-processing method as claimed in claim 4, wherein said judging determines that the failure-recovering is not possible when the failure-recovering information indicates a lower expanding attribute and an upward illegal access to the memory is detected.

10. The information-processing method as claimed in claim 4, wherein said judging determines that the failure-recovering is not possible when the failure-recovering information indicates a fixed size attribute.

11. The information-processing method as claimed in claim 1, wherein said performing failure-recovering processes includes:
allocating some other area of the memory than an area of the memory where the illegal access has occurred; and
accessing the other area of the memory allocated by said allocating.

12. The information-processing method as claimed in claim 1, wherein the failure-recovering information includes an item of a terminator attribute, and
wherein, when the terminator attribute indicates that data should have a terminated value at the end, said failure-recovering processes includes adding the terminated value to the end of the data.

13. An information-processing apparatus, comprising:
a memory;
an address register operable to store an address of said memory, range information, and failure-recovering information;
an illegal access-detecting unit operable to refer said address register to detect illegal access to said memory;
an ordinary processing unit operable to access said memory to perform ordinary processes;
an failure recovery-judging unit operable to refer said address register to judge whether or not failure-recovering is possible when said illegal access-detecting unit detects the illegal access to said memory; and
a failure-recovering unit operable to perform failure-recovering when said failure recovery-judging unit judges that the failure-recovering is possible.

14. The information-processing apparatus as claimed in claim 13, further comprising:
a halt processing unit operable to perform halt processes when said failure recovery-judging unit judges that the failure-recovering is not possible.

15. A failure information-supervising system, comprising:
an information-processing apparatus; and
an information center operable to communicate with said information-processing apparatus to transmit failure-recovering information,
wherein said information-processing apparatus, comprising:
a memory;
an address register operable to store an address of said memory, range information, and failure-recovering information;
an illegal access-detecting unit operable to refer said address register to detect illegal access to said memory;
an ordinary processing unit operable to access said memory to perform ordinary processes;
an failure recovery-judging unit operable to refer said address register to judge whether or not failure-recovering is possible when said illegal access-detecting unit detects the illegal access to said memory; and
a failure-recovering unit operable to perform failure-recovering when said failure recovery-judging unit judges that the failure-recovering is possible.

16. A processor, comprising:
an address register operable to store an address of an external memory, range information, and failure-recovering information;
a command-processing unit operable to refer said address register to access the external memory; and
an illegal access-detecting unit operable to refer said address register,
wherein said illegal access-detecting unit outputs exception signals to said command-processing unit when said illegal access-detecting unit detects that said command-processing unit has illegally accessed the external memory.

17. A compile method, comprising:
compiling a source code written in programming language supporting a pointer;
generating a code for the pointer to point to a variable area according to the source code, the pointer including a pointer value; and
setting to the pointer value a set of an address of the variable area, range information of the variable area, and failure-recovering information utilized when illegal access to the variable area occurs.

18. A compile method, comprising:
compiling a source code written in programming language supporting a pointer;
generating a code for the pointer to point to a variable area according to the source code, the pointer including a pointer value;
setting to the pointer value an address of the variable area and range information of the variable area; and
setting, to the variable area pointed by the pointer value, failure-recovering information utilized when illegal access to the variable area occurs.

19. The compile method as claimed in claim 17, wherein the failure-recovering information is managed separately from the source code.

20. The compile method as claimed in claim 17, further comprising:
adding the failure-recovering information to the source code to generate an intermediate code.

21. A compiler, comprising:
a language-parsing unit operable to compile a source code written in programming language supporting a pointer to output a code; and
a code-generating unit operable to add a code for failure-recovering information to the code outputted from said language-parsing unit, the code for the failure-recovering information corresponding to a variable being included in the code outputted from said language-parsing unit.
